(19) United States
(12) Patent Application Publication
(10) Pub. No.: US 2022/0027673 A1
(43) Pub. Date: Jan. 27, 2022

(54) SELECTING DEVICE AND SELECTING METHOD

(71) Applicant: Nippon Telegraph and Telephone Corporation, Tokyo (JP)

(72) Inventor: Takeshi Yamada, Musashino-shi, Tokyo (JP)

(21) Appl. No.: 17/273,428

(22) PCT Filed: Aug. 26, 2019
(86) PCT No.: PCT/JP2019/033289

§ 371 Date: Mar. 4, 2021

(30) Foreign Application Priority Data
Sep. 19, 2018 (JP) 2018-174530

(51) Int. Cl. G06K 9/62; G06F 40/169

(52) U.S. Cl. CPC G06K 9/6256; G06F 40/169; G06K 9/6215

(57) ABSTRACT

A calculation unit (15a) calculates a degree of similarity between each of training data candidates that are documents to which predetermined tags corresponding to descriptions therein have been added and test data that is a document to which tags are to be added, a selection unit (15b) selects, as training data, a training data candidate of which the degree of similarity thus calculated is no less than a predetermined threshold value, and an addition unit (15c) performs learning using the training data thus selected, and adds the tags to the test data according to a result of learning. The calculation unit (15a) may calculate the degree of similarity by using the frequency of appearance of a predetermined word that appears in the training data candidates and the test data. The calculation unit (15a) may calculate the degree of similarity by using the frequency of appearance of a predetermined word in each of the tags added to training data candidates.

### TECHNICAL FIELD

The present invention relates to a selection apparatus and a selection method.

### BACKGROUND ART

In recent years, a technique for automatically extracting test items corresponding to development requirements from a document such as a design document written by a non-engineer using a natural language has been studied (see PTL 1). This technique adds tags to important description portions in a design document, using a machine learning method (CRF: Conditional Random Fields), for example, and automatically extracts test items from the tagged portions.

### CITATION LIST

### Patent Literature

[PTL 1] Japanese Patent Application Publication No. 2018-018373

### SUMMARY OF THE INVENTION

### Technical Problem

However, with the conventional technique, it may be difficult to appropriately add tags to a document. For example, learning regarding tagging to a document has been performed by using as many natural language documents as possible as training data regardless of categories. Therefore, the result of learning may diverge as a result of machine learning being performed using, as training data, documents in a different category than the document from which test items are to be extracted. Accordingly, a large number of mismatches may occur between the test items automatically extracted using the result of learning and the test items extracted in the actual development.

The present invention has been made in view of the foregoing and an object thereof is to appropriately add tags to a document using appropriate training data.

### Means for Solving the Problem

To solve the above-described problems and fulfill the object, a selection apparatus according to the present invention includes: a calculation unit that calculates a degree of similarity between each of training data candidates that are documents to which predetermined tags corresponding to descriptions therein have been added and test data that is a document to which the tags are to be added; a selection unit that selects a training data candidate of which the degree of similarity thus calculated is no less than a predetermined threshold value, as training data; and an addition unit that performs learning using the training data thus selected, and adds the tags to the test data according to a result of learning.

### Effects of the Invention

According to the present invention, it is possible to appropriately add tags to a document, using appropriate training data.

### BRIEF DESCRIPTION OF DRAWINGS

FIG. 1 is a diagram illustrating an outline of processing performed by a system that includes a selection apparatus according to an embodiment.

FIG. 2 is a diagram illustrating an outline of processing performed by the system that includes the selection apparatus according to the embodiment.

FIG. 3 is a diagram illustrating an outline of processing performed by the selection apparatus according to the embodiment.

FIG. 4 is a diagram illustrating an outline of processing performed by the selection apparatus according to the embodiment.

FIG. 5 is a schematic diagram illustrating a schematic configuration of the selection apparatus according to the embodiment.

FIG. 6 is a diagram illustrating processing performed by a calculation unit.

FIG. 7 is a diagram illustrating processing performed by the calculation unit.

FIG. 8 is a diagram illustrating processing performed by the calculation unit and a selection unit.

FIG. 9 is a flowchart showing selection processing procedures.

FIG. 10 is a diagram showing an example of a computer that executes a selection program.

### DESCRIPTION OF EMBODIMENTS

Hereinafter, an embodiment of the present invention will be described in detail with reference to the drawings. Note that the present invention is not limited to the embodiment. Also note that the same parts in the drawings are indicated by the same reference numerals.

[System Processing]

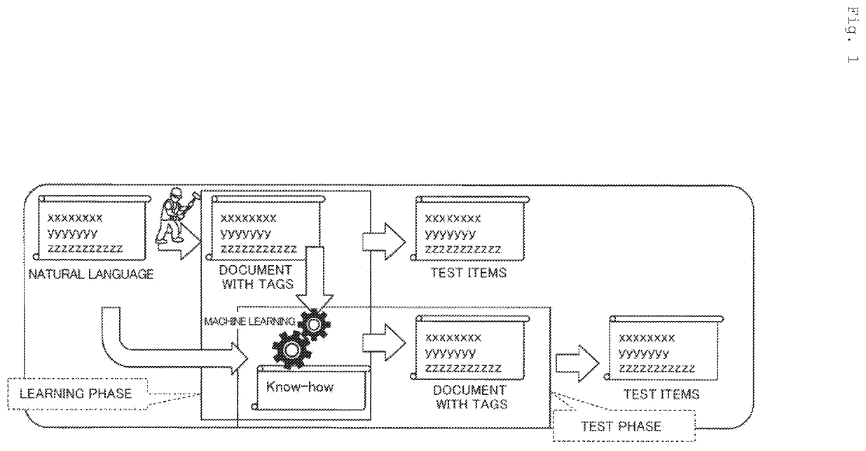

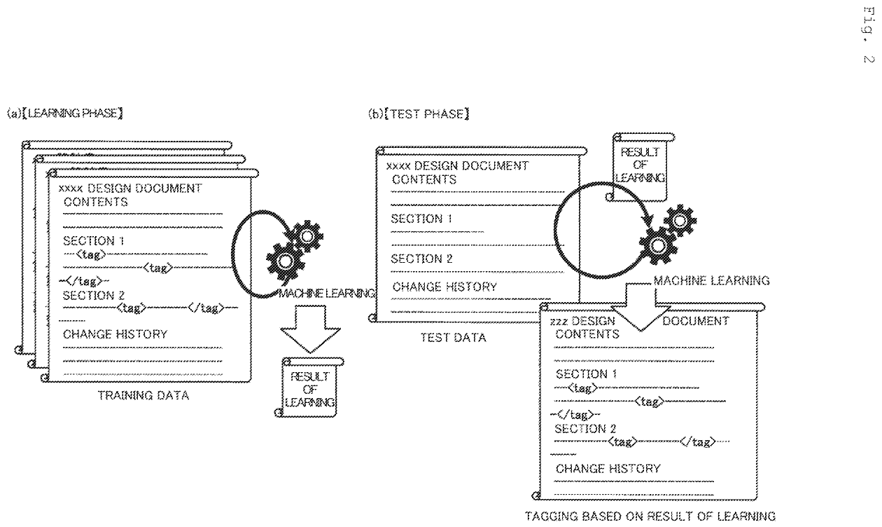

FIGS. 1 and 2 are diagrams illustrating an outline of processing performed by the system that includes a selection apparatus according to the embodiment. The system including the selection apparatus according to the present embodiment executes test item extraction processing. First, as shown in FIG. 1, the system adds tags to important description portions that indicate develop requirements or the like in a document such as a design document written in a natural language. Next, the system automatically extracts test items from the portions indicated by the tags in the tagged document (see PTL 1).

Here, in a learning phase, the system performs machine learning to learn tagging, by using documents to which tags have been manually added, as training data. Also, in a test phase, the system adds tags to test data that is a document to be subjected to test item extraction processing for extracting test items, using the result of learning obtained in the learning phase.

Specifically, as shown in FIG. 2(a), in the learning phase, the system uses training data in which tags have been added to important description portions, as input information, to learn a tagging tendency in the training data by performing probabilistic calculations, and outputs the tendency as the result of learning. For example, the system learns a tagging tendency based on the positions and the types of the tags, words before and after each tag, context, and so on. Also, as shown in FIG. 2(b), in the test phase, the system adds tags to the test data, using the result of learning indicating the tagging tendency in the training data, obtained in the learning phase.

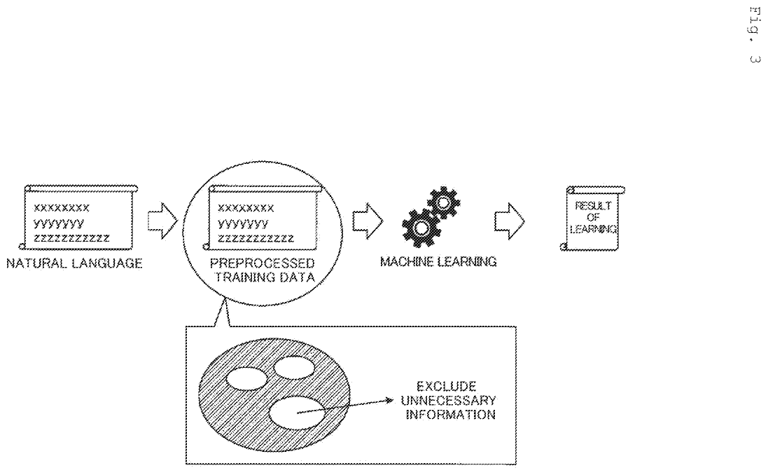

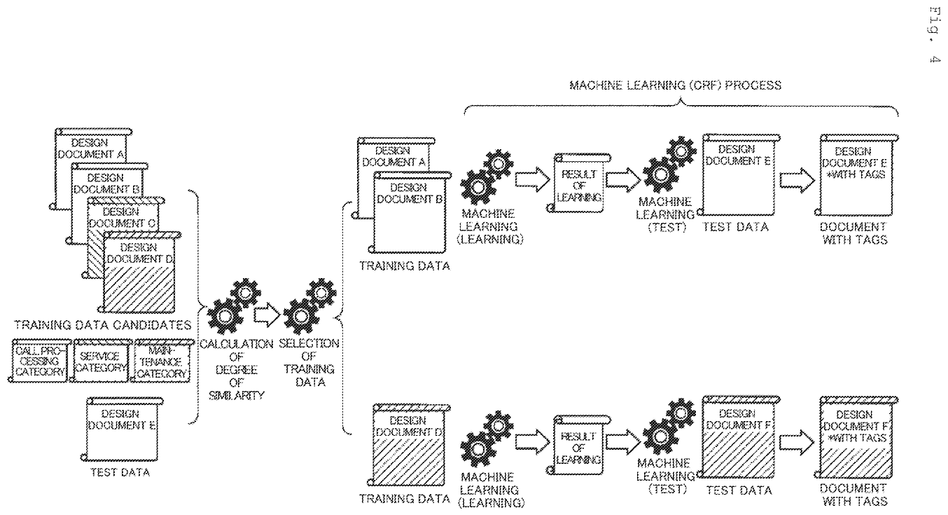

Here, FIGS. 3 and 4 are diagrams illustrating an outline of processing performed by the selection apparatus according to the embodiment. In the above-described learning phase, for example, if machine learning is performed using a document in a different category than the test data, as training data, the result of learning may diverge and accuracy in learning may be degraded. For example, in a document in a call processing category, “a call processing process” is often described as the subject, such as “two call processing processes are simultaneously executed during normal operation”. In contrast, in a document in a maintenance category, “a call processing process” is often described as the object, such as “a maintenance person monitors the number of operating call processing processes on a maintenance screen”. In this way, documents in different categories may have different description tendencies.

Therefore, as shown in FIG. 3, the selection apparatus in the present embodiment performs preprocessing on training data that is to be used in the test phase, to exclude unnecessary information, in order to obtain an appropriate result of learning in the test phase. Specifically, as shown in FIG. 4, the selection apparatus selects a training data candidate of which the degree of similarity to the test data is high as training data from among a large number of training data candidates, through the selection processing described below.

In the example shown in FIG. 4, a document in the same category as the test data is selected as a training data candidate of which the degree of similarity to the test data is high, from among training data candidates in different categories such as a call processing category, a service category, and a maintenance category. For example, when test data is a design document E, design documents A and B in the same call processing category as the design document E are selected as training data. On the other hand, when test data is a design document F in the maintenance category, a design document D in the same maintenance category as the design document F is selected as training data.

In this way, the selection apparatus performs learning using training data of which the degree of similarity to test data is high, and thus improves accuracy in learning tagging. As a result, the system including the selection apparatus can appropriately extract test items from test data to which tags have been appropriately added in the above-described test phase.

[Configuration of Selection Apparatus]

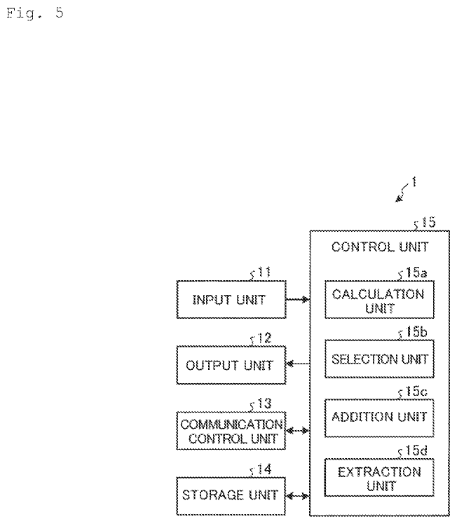

FIG. 5 is a schematic diagram illustrating a schematic configuration of the selection apparatus according to the embodiment. As illustrated in FIG. 5, the selection apparatus 10 is realized using a general-purpose computer such as a personal computer, and includes an input unit 11, an output unit 12, a communication control unit 13, a storage unit 14, and a control unit 15.

The input unit 11 is realized using an input device such as a keyboard or a mouse, and inputs various kinds of instruction information such as an instruction to start processing to the control unit 15 in response to an operation input by an operator. The output unit 12 is realized using a display device such as a liquid crystal display or a printing device such as a printer, for example.

The communication control unit 13 is realized using a NIC (Network Interface Card) or the like, and controls communication between an external device and the control unit 15 via a telecommunication line such as a LAN (Local Area Network) or the Internet.

The storage unit 14 is realized using a semiconductor memory device such as a RAM (Random Access Memory) or a flash memory (Flash Memory), or a storage device such as a hard disk or an optical disc, and stores a batch or the like created through the selection processing described below. Note that the storage unit 14 may be configured to communicate with the control unit 15 via the communication control unit 13.

The control unit 15 is realized using a CPU (Central Processing Unit) or the like, and executes a processing program stored in a memory. As a result, as illustrated in FIG. 5, the control unit 15 function as a calculation unit 15a, a selection unit 15b, an addition unit 15c, and an extraction unit 15d. Note that these functional units may be respectively implemented on different pieces of hardware, or some of these functional units may be implemented on a different piece of hardware. For example, the extraction unit 15d may be implemented on a piece of hardware that is different from the piece of hardware on which the calculation unit 15a, the selection unit 15b, and the addition unit 15c are implemented.

The calculation unit 15a calculates the degree of similarity between each of training data candidates that are documents to which predetermined tags corresponding to descriptions therein have been added and test data that is a document to which tags are to be added.

Here, examples of tags corresponding to descriptions in a document include “Agent”, “Input”, “Input condition”, “Condition”, “Output”, “Output condition”, and “Check point”, which indicate requirements defined in a design document.

“Agent” indicates a target system. “Input” indicates input information to the system. “Input condition” indicates an input condition. “Condition” indicates a system condition. “Output” indicates output information from the system. “Output condition” indicates an output condition. “Check point” indicates a check point or a check item.

The calculation unit 15a calculates the degree of category similarity between each of a large number of training data candidate documents in different categories and test data that is a document to which tags are to be added in the test phase, as the degree of similarity between each training data candidate and the test data.

The calculation unit 15a may calculate the degree of similarity by using the frequency of appearance of a predetermined word that appears in the training data candidates and the test data.

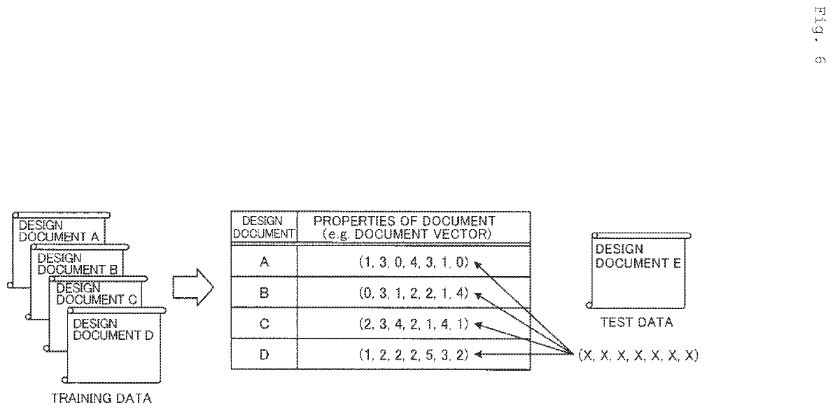

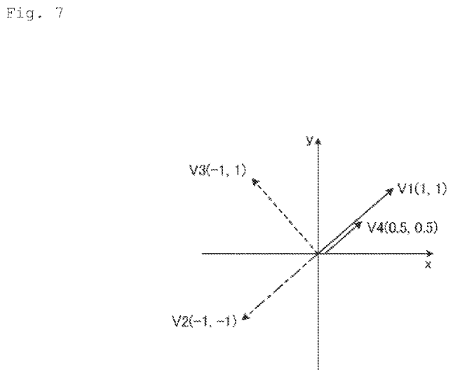

Here, FIGS. 6 and 7 are diagrams illustrating processing performed by the calculation unit 15a. As shown in FIG. 6, the calculation unit 15a calculates, as a property of each document, a document vector that represents the frequency of appearance of a predetermined word, in the form of a vector. In the example shown in FIG. 6, the document vector of each document is represented as a seven-dimensional vector that has the respective frequencies of appearance of seven predetermined words as elements, such as (the frequency of appearance of a word α1, the frequency of appearance of a word α2, . . . , the frequency of appearance of a word α7). FIG. 6 shows, for example, that the word α1, the word α2, the word α4, the word α5, and the word α6 appear in a design document A, and the respective frequencies of appearance are 1, 3, 4, 3, and 1. Note that a frequency of appearance is represented as the number of appearances or the ratio of the number of appearances to the total number of words, for example.

Also, the calculation unit 15a calculates, as the degree of similarity, a cosine similarity between document vectors, for example. Here, a cosine similarity is calculated using the inner product of vectors as shown in the following formula (1), and is equivalent to the correlation coefficient of two vectors.

$$[ Formula 1 ]$$

$$cos ( \overline{{V}_{x}} , \overline{{V}_{y}} ) = \frac{\overline{{V}_{x}} \cdot \overline{{V}_{y}}}{\vert \overline{{V}_{x}} \vert \vert \overline{{V}_{y}} \vert} \qquad ( 1 )$$

For example, the cosine similarity between V1(1,1) and V2(−1,−1) that forms an angle of 180 degrees with V1 in FIG. 7 is calculated as −2. The cosine similarity between V1 and V3(−1,1) that forms an angle of 90 degrees with V1 is calculated as 0. The cosine similarity between V1 and V4(0.5,0.5) that forms an angle of 0 degrees with V1 is calculated as 0.5.

The calculation unit 15a may calculate the degree of similarity by using the respective frequencies of appearance of predetermined words in each of the tags added to training data candidates. Here, it is envisaged that words that reflect the properties of a document show different tendencies in each portion indicated by a tag in the document. Therefore, the calculation unit 15a calculates the degree of similarity between each of the training data candidates and test data, using a word of which the degree of association with a tag is high.

Specifically, the calculation unit 15a quantitatively evaluates the degree of association with a tag, using pointwise mutual information PMI shown in the following formula (2).

[Formula 2]

PMI(x,y)=−log P(y)−{−log P(y|x)} (2)

where P(y) denotes the probability of a given word y appearing in the document, and

P(y|x) denotes the probability of the given word y appearing in the tag.

In the above formula (2), the first term (−log p(y)) on the right side indicates the amount of information when the given word y appears in the document. The second term {−log P(y|x)} on the right side indicates the amount of information when a precondition x (in the tag) and the word y co-occur. Thus, it is possible to quantitatively evaluate the degree of association of a word with a tag.

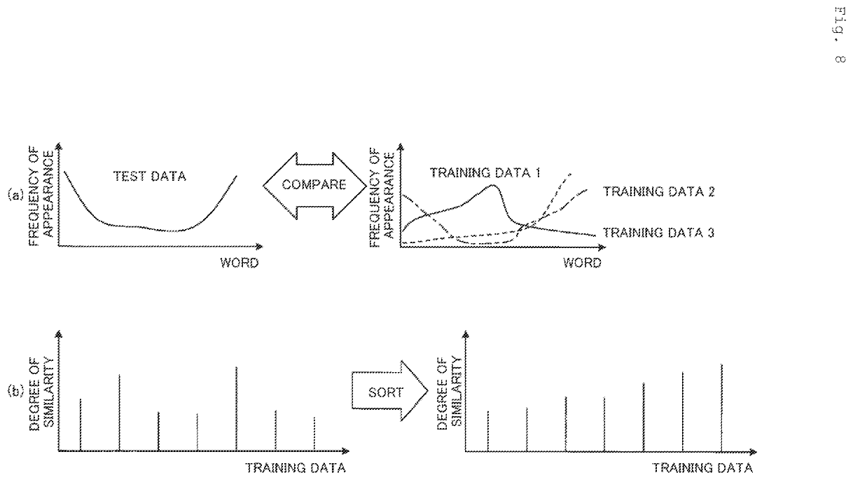

The selection unit 15b selects, as training data, a training data candidate of which the degree of similarity thus calculated is no less than a predetermined threshold value. Here, FIG. 8 is a diagram illustrating processing performed by the calculation unit 15a and the selection unit 15b. As shown in FIG. 8(a), the calculation unit 15a compares test data and each training data (candidate) in terms of the respective frequencies of appearance of predetermined words, to calculate the degree of similarity. The selection unit 15b, as shown in FIG. 8(b), sorts the degrees of similarity in ascending order for each training data (candidate), and selects, as training data, a training data (candidate) of which the degree of similarity is no less than a predetermined threshold value, for example.

The addition unit 15c performs learning using the selected training data, and adds tags to the test data according to the result of learning. Specifically, using the result of learning obtained in the learning phase and indicating the tagging tendency in the training data, the addition unit 15c adds tags to the test data according to the tagging tendency in the training data. Thus, appropriate tags are accurately added to the test data.

The extraction unit 15d extracts test items from the test data to which tags have been added. For example, the extraction unit 15d references tags added by the addition unit 15c to important description portions indicating develop requirements or the like in a document, and automatically extracts test items for the portion indicated by the tags, by using statistical information regarding tests conducted on the same or a similar portion. As a result, the extraction unit 15d can automatically extract appropriate test items from test data written in a natural language.

[Selection Processing]

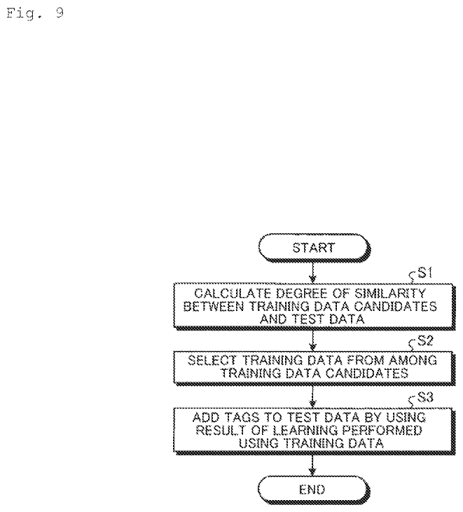

Next, selection processing performed by the selection apparatus 10 according to the present embodiment will be described with reference to FIG. 9. FIG. 9 is a flowchart showing selection processing procedures. The flowchart in FIG. 9 is started upon a user performing an operation to input a start instruction, for example.

First, the calculation unit 15a calculates the degree of similarity between each training data candidate to which predetermined tags corresponding to descriptions have been added and test data (step S1). For example, the calculation unit 15a calculates the degree of similarity between each of the training data candidates and the test data, using the frequency of appearance of a predetermined word in the training data candidates and the test data. At this time, the calculation unit 15a may calculate, for each of the tags added to the training data candidates, the degree of similarity between the training data candidates and the test data by using the frequency of appearance of a word of which the degree of association with the tag is high.

Next, the selection unit 15b selects, as training data, a training data candidate of which the degree of similarity thus calculated is no less than a predetermined threshold value (step S2). Also, the addition unit 15c adds tags to the test data according to the result of learning performed using the training data thus selected (step S3). In other words, the addition unit 15c adds tags to the test data, using the result of learning obtained in the learning phase and indicating the tagging tendency in the training data.

Thus, the series of selection processing is complete, and tags are appropriately added to the test data. Thereafter, the extraction unit 15d extracts test items from the test data to which tags have been appropriately added, by using statistical information regarding tests conducted on portions that are the same as, or similar to, the portions indicated by the tags.

As described above, in the selection apparatus 10 according to the present embodiment, the calculation unit 15a calculates the degree of similarity between each of training data candidates that are documents to which predetermined tags corresponding to descriptions therein have been added and test data that is a document to which tags are to be added. The selection unit 15b selects, as training data, a training data candidate of which the degree of similarity thus calculated is no less than a predetermined threshold value. The addition unit 15c performs learning using the selected training data, and adds tags to the test data according to the result of learning.

Thus, the selection apparatus 10 only selects a training data candidate that is similar to the test data, such as a training data candidate that is in the same category as the test data, as training data. Therefore, it is possible to learn tagging tendency in the training data similar to the test data, and obtain an accurate result of learning with suppressed divergence. Also, the selection apparatus 10 can accurately add appropriate tags to test data according to the tagging tendency in training data, which is the result of learning. In this way, the selection apparatus 10 can learn tagging by using appropriate training data, and can appropriately add tags to test data written in a natural language.

As a result, the extraction unit 15d can accurately extract appropriate test items with reference to the tags appropriately added to the test data, by using statistical information regarding tests conducted on portions that are the same as, or similar to, the portions indicated by the tags. In this way, in the selection apparatus 10, the extraction unit 15d can automatically extract appropriate test items from test data written in a natural language.

The calculation unit 15a may calculate the degree of similarity by using the frequency of appearance of a predetermined word that appears in the training data candidates and the test data. As a result, it is possible to select a document that have similar properties to the test data, as training data.

At this time, the calculation unit 15a may calculate the degree of similarity by using the frequency of appearance of a predetermined word in each of the tags added to training data candidates. In this way, by using the frequency of appearance of a word that has a different appearance tendency in each tag, accuracy in learning tagging is improved, and it is possible to more appropriately add tags to test data.

[Program]

It is also possible to create a program that describes the processing executed by the selection apparatus 10 according to the above-described embodiment, in a computer-executable language. In one embodiment, the selection apparatus 10 can be implemented by installing a selection program that executes the above-described selection processing, as packaged software or online software, on a desired computer. For example, by causing an information processing apparatus to execute the above-described selection program, it is possible to enable the information processing apparatus to function as the selection apparatus 10. The information processing apparatus mentioned here may be a desktop or a laptop personal computer. In addition, the scope of the information processing apparatus also includes mobile communication terminals such as a smartphone, a mobile phone, and a PHS (Personal Handyphone System), and slate terminals such as a PDA (Personal Digital Assistant), for example. Also, the functions of the selection apparatus 10 may be implemented on a cloud server.

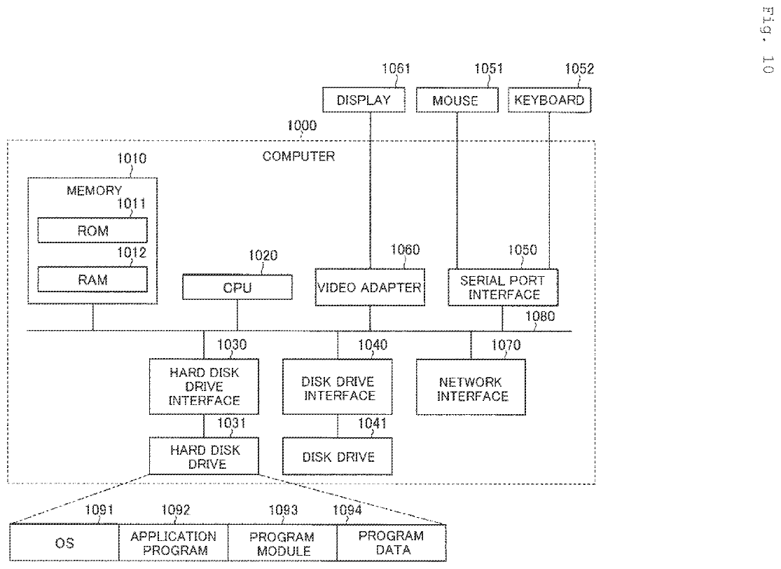

FIG. 10 is a diagram showing an example of a computer that executes the selection program. A computer 1000 includes, for example, a memory 1010, a CPU 1020, a hard disk drive interface 1030, a disk drive interface 1040, a serial port interface 1050, a video adapter 1060, and a network interface 1070. These units are connected via a bus 1080.

The memory 1010 includes a ROM (Read Only Memory) 1011 and a RAM 1012. The ROM 1011 stores a boot program such as a BIOS (Basic Input Output System) program, for example. The hard disk drive interface 1030 is connected to a hard disk drive 1031. The disk drive interface 1040 is connected to a disk drive 1041. For example, a removable storage medium such as a magnetic disc or an optical disc is inserted into the disk drive 1041. The serial port interface 1050 is connected to a mouse 1051 and a keyboard 1052, for example. The video adapter 1060 is connected to a display 1061, for example.

The hard disk drive 1031 stores an OS 1091, an application program 1092, a program module 1093, and program data 1094, for example. The various kinds of information described in the above embodiment are stored in the hard disk drive 1031 or the memory 1010, for example.

The selection program is stored on the hard disk drive 1031 as the program module 1093 in which instructions to be executed by the computer 1000 are written, for example. Specifically, the program module 1093 in which each kind of processing to be executed by the selection apparatus 10 described in the above embodiment is stored on the hard disk drive 1031.

Data used in the information processing performed by the selection program is stored on the hard disk drive 1031 as the program data 1094, for example. The CPU 1020 reads out the program module 1093 or the program data 1094 stored on the hard disk drive 1031 to the RAM 1012 as necessary, and executes the above-described procedures.

Note that the program module 1093 and the program data 1094 pertaining to the selection program are not limited to being stored on the hard disk drive 1031, and may be stored on a removable storage medium, for example, and read out by the CPU 1020 via the disk drive 1041 or the like. Alternatively, the program module 1093 and the program data 1094 pertaining to the selection program may be stored in another computer connected via a network such as a LAN (Local Area Network) or a WAN (Wide Area Network), and read out by the CPU 1020 via the network interface 1070.

An embodiment to which the invention made by the inventors is applied has been described above. However, the present invention is not limited by the descriptions or the drawings according to the present embodiment that constitute a part of the disclosure of the present invention. That is to say, other embodiments, examples, operational technologies, and so on that can be realized based on the present embodiment, by a person skilled in the art or the like, are all included in the scope of the present invention.

### REFERENCE SIGNS LIST

10 Selection apparatus
11 Input unit
12 Output unit
13 Communication control unit
14 Storage unit
15 Control unit
15a Calculation unit
15b Selection unit
15c Addition unit
15d Extraction unit

1. A selection apparatus comprising: a calculation unit, including one or more processors, configured to calculate a degree of similarity between each of training data candidates that are documents to which predetermined tags corresponding to descriptions therein have been added and test data that is a document to which the tags are to be added; a selection unit, including one or more processors, configured to select a training data candidate of which the degree of similarity thus calculated is no less than a predetermined threshold value, as training data; and an addition unit, including one or more processors, configured to perform learning using the training data thus selected, and add the tags to the test data according to a result of learning.

2. The selection apparatus according to claim 1, wherein the calculation unit is configured to calculate the degree of similarity by using a frequency of appearance of a predetermined word that appears in the training data candidates and the test data.

3. The selection apparatus according to claim 2, wherein the calculation unit is configured to calculate the degree of similarity by using the frequency of appearance of a predetermined word in each of the tags added to the training data candidates.

4. A selection method carried out by a selection apparatus, comprising: a calculation step of calculating a degree of similarity between each of training data candidates that are documents to which predetermined tags corresponding to descriptions therein have been added and test data that is a document to which the tags are to be added; a selection step of selecting a training data candidate of which the degree of similarity thus calculated is no less than a predetermined threshold value, as training data; and an addition step of performing learning using the training data thus selected, and adding the tags to the test data according to a result of learning.

5. The selection method according to claim 4, wherein the calculation step includes calculating the degree of similarity by using a frequency of appearance of a predetermined word that appears in the training data candidates and the test data.

6. The selection method according to claim 5, wherein the calculation step includes calculating the degree of similarity by using the frequency of appearance of a predetermined word in each of the tags added to the training data candidates.
